(19) United States
(12) Patent Application Publication
(10) Pub. No.: US 2016/0176295 A1
(43) Pub. Date: Jun. 23, 2016

(54) VEHICLE CONTROL DEVICE

(71) Applicant: TOYOTA JIDOSHA KABUSHIKI KAISHA, Toyota-shi, Aichi-ken (JP)

(72) Inventors: Yoshitaka NIIMI, Anjo-shi, Aichi-ken (JP); Masaki OKAMURA, Miyoshi-shi, Aichi-ken (JP); Shintaro TSUJII, Miyoshi-shi, Aichi-ken (JP); Wanleng ANG, Okazaki-shi, Aichi-ken (JP); Hideaki YAGUCHI, Okazaki-shi, Aichi-ken (JP); Keisuke MORISAKI, (JP)

(73) Assignee: TOYOTA JIDOSHA KABUSHIKI KAISHA, Toyota-shi, Aichi-ken (JP)

(21) Appl. No.: 14/910,190

(22) PCT Filed: Aug. 5, 2014
(86) PCT No.: PCT/IB2014/001461

§ 371 Date: Feb. 4, 2016

(30) Foreign Application Priority Data
Aug. 6, 2013 (JP) 2013-163384

(51) Int. Cl. B60L 3/12; B60L 3/00; B60L 15/20

(52) U.S. Cl. CPC B60L 3/12; B60L 15/20; B60L 3/0069

(57) ABSTRACT

A vehicle control device that controls a vehicle including a first electric motor that is driven at a rotation speed synchronized with a rotation speed of a drive shaft of the vehicle includes an electronic control unit. The electronic control unit is configured to carry out first determination that determines whether the rotation speed of the first electric motor is lower than or equal to a first threshold and whether a stop operation that stops the vehicle is being carried out, and to carry out second determination that the vehicle is stopped when the electronic control unit has determined in the first determination that the rotation speed of the first electric motor is lower than or equal to the first threshold and the stop operation is being carried out.

### BACKGROUND OF THE INVENTION

1. Field of the Invention

The invention relates to, for example, a technical field of a vehicle control device that controls a vehicle including an electric motor.

2. Description of Related Art

In recent years, a vehicle including an electric motor (a so-called motor) has become a focus of attention. As an example of such a vehicle including an electric motor, there is known a hybrid vehicle including both an electric motor and an internal combustion engine (see, for example, Japanese Patent Application Publication No. 2006-288051 (JP 2006-288051 A)). In addition, as such a vehicle including an electric motor, there is known an electric vehicle including an electric motor but not including an internal combustion engine (see, for example, Japanese Patent Application Publication No. 7-241002 (JP 7-241002 A)).

JP 2006-288051 A describes a technique for, in the thus configured hybrid vehicle, executing three-phase short-circuit control over the electric motor in order to early stop rotation of the internal combustion engine when the rotation speed of the internal combustion engine is lower than a predetermined rotation speed.

JP 7-241002 A describes a technique for, in the thus configured electric vehicle, setting all the switching elements in one of two different types of switching elements to an off state and setting at least one of the switching elements in the other one of the two different types of switching elements to an on state in order to carry out detection of a ground fault. The switching elements constitute an inverter that supplies electric power to the electric motor.

In the technique described in JP 7-241002 A, the states of the switching elements are fixed at the time of carrying out an operation to carry out detection of a ground fault, so it is desirable that the electric motor be stopped. Thus, at the time of carrying out an operation to carry out detection of a ground fault by using the technique described in JP 7-241002 A, it is desirable that the vehicle be stopped. That is, at the time of carrying out an operation to carry out detection of a ground fault by using the technique described in JP 7-241002 A, it is desirable to perform an operation to determine whether the vehicle is stopped before an operation to carry out detection of a ground fault is carried out. In other words, after it is determined that the vehicle is stopped, it is desirable to perform an operation to carry out detection of a ground fault by using the technique described in JP 7-241002 A.

Therefore, as the operation to determine whether the vehicle is stopped, it is conceivable that an operation to determine whether the rotation speed of the internal combustion engine is lower than a predetermined rotation speed (that is, the technique described in JP 2006-288051 A) may be used. The “rotation speed of the internal combustion engine” that is used as a determination criterion as to whether the vehicle is stopped is typically calculated on the basis of an output of a crank angle sensor. However, considering the accuracy of the rotation speed of the internal combustion engine, which is calculated from the output of the crank angle sensor, there arises a technical problem that it is difficult to highly accurately determine whether the vehicle is stopped on the basis of the rotation speed of the internal combustion engine. For example, there arises a technical problem that it may be erroneously determined that the vehicle is stopped because of, for example, an accuracy error of the rotation speed of the internal combustion engine, which is calculated from the output of the crank angle sensor, although the vehicle is not stopped.

The above-described technical problems will be described in detail below. That is, the above-described technical problems can arise not only when the operation to determine whether the vehicle is stopped is carried out in association with the operation to carry out detection of a ground fault by using the technique described in JP 7-241002 A but also when the operation to determine whether the vehicle is stopped is carried out.

### SUMMARY OF THE INVENTION

A task that the invention is intended to solve includes the above-described ones as examples. The invention provides a vehicle control device that is able to highly accurately determine whether the vehicle is stopped.

An aspect of the invention provides a vehicle control device that controls a vehicle including a first electric motor that is driven at a rotation speed synchronized with a rotation speed of a drive shaft of the vehicle. The vehicle control device includes an electronic control unit described as follows. That is, the electronic control unit is configured to carry out first determination as to whether the rotation speed of the first electric motor is lower than or equal to a first threshold and whether a stop operation that stops the vehicle is being carried out, and configured to carry out second determination that the vehicle is stopped when in the first determination the electronic control unit determines that the rotation speed of the first electric motor is lower than or equal to the first threshold and the stop operation is being carried out.

With the thus configured vehicle control device, it is possible to control the vehicle including the first electric motor. The first electric motor is provided in the vehicle such that the rotation speed of the first electric motor synchronizes with the rotation speed of the drive shaft of the vehicle. The “state where the rotation speed of the first electric motor synchronizes with the rotation speed of the drive shaft” means a state where the rotation speed of the first electric motor and the rotation speed of the drive shaft have a correlation. Typically, the “state where the rotation speed of the first electric motor synchronizes with the rotation speed of the drive shaft” means a state where the rotation speed of the first electric motor is directly proportional to the rotation speed of the drive shaft (that is, (the rotation speed of the first electric motor)×K (where K is a selected constant)=(the rotation speed of the drive shaft). The “state where the rotation speed of the first electric motor synchronizes with the rotation speed of the drive shaft” may be implemented by directly coupling the rotary shaft of the first electric motor to the drive shaft. Alternatively, the “state where the rotation speed of the first electric motor synchronizes with the rotation speed of the drive shaft” may be implemented by indirectly coupling the rotary shaft of the first electric motor to the drive shaft via any mechanical mechanism (for example, a speed reduction gear mechanism).

In the thus configured vehicle control device, the electronic control unit is configured to carry out the first determination and the second determination in order to determine whether the vehicle including the first electric motor is stopped.

In the first determination, determination operation based on the rotation speed of the first electric motor is performed. Specifically, it is determined whether the rotation speed of the first electric motor is lower than or equal to a first threshold. In addition, in the first determination, determination operation based on whether there is a stop operation that can stop the vehicle is performed. Specifically, in the first determination, it is determined whether the stop operation that stops the vehicle is being carried out.

In the second determination, it is determined whether the vehicle is stopped on the basis of the determination result of the first determination. Specifically, in the second determination, when it is determined in the first determination that the rotation speed of the first electric motor is lower than or equal to the first threshold and the stop operation is being carried out, it is determined that the vehicle is stopped. On the other hand, in the second determination, when it is determined in the first determination that the rotation speed of the first electric motor is not lower than or equal to the first threshold, it may be determined that the vehicle is not stopped. Similarly, in the second determination, when it is determined in the first determination that the stop operation is not being carried out, it may be determined that the vehicle is not stopped.

As described above, the vehicle control device according to the invention is able to determine whether the vehicle is stopped on the basis of not only the rotation speed of the first electric motor but also whether there is the stop operation. Therefore, the thus configured vehicle control device is able to relatively highly accurately determine whether the vehicle is stopped in comparison with a vehicle control device according to a first comparative embodiment, which determines that the vehicle is stopped when a rotation speed of an internal combustion engine, of which detection accuracy can be lower than the detection accuracy of the rotation speed of the first electric motor, is lower than or equal to a predetermined threshold. In addition, the vehicle control device according to the invention is able to relatively highly accurately determine whether the vehicle is stopped in comparison with a vehicle control device according to a second comparative embodiment, which determines that the vehicle is stopped when the rotation speed of the first electric motor is lower than or equal to a predetermined threshold without determining whether the stop operation is being carried out.

In the vehicle control device, the first electric motor may be a three-phase alternating-current motor, the vehicle may include a pair of serially connected first switching element and second switching element in each of the three phases of the first electric motor, the vehicle may further include a first power converter that converts direct-current power to alternating-current power, the direct-current power being supplied to the first electric motor. The electronic control unit may be configured to execute first control that controls the first power converter such that a state of the first power converter is set to a specific state where one of the set of first switching elements all and the set of second switching elements all are in an off state and at least one switching element of the other one of the set of first switching elements and the set of second switching elements is in an on state, when the electronic control unit has carried out the second determination that the vehicle is stopped.

In the control device, the first electric motor, which is a three-phase alternating-current motor, is driven with electric power that is supplied from the first power converter (that is, alternating-current power).

In order to supply electric power to the first electric motor, which is a three-phase alternating-current motor, the first power converter includes the pair of serially connected first switching element (for example, the switching element electrically connected between a high-voltage-side terminal of a power supply and the first electric motor) and second switching element (for example, a switching element electrically connected between a low-voltage-side terminal of the power supply and the first electric motor) in each of the three phases. That is, the first power converter includes the first and second switching elements arranged in the U phase, the first and second switching elements arranged in the V phase and the first and second switching elements arranged in the W phase.

Particularly, the electronic control unit includes first control that controls the first power converter. In the first control, the first power converter may be controlled such that the state of the first power converter becomes the specific state (typically, the state of the first power converter is fixed to the specific state) when in the second determination the electronic control unit determines that the vehicle is stopped. Here, the “specific state” is a state where one of the set of first switching elements and the set of second switching elements all are in an off state (that is, an interrupted state) and at least one of the other one of the set of first switching elements and the set of second switching elements is in an on state (that is, a connected state).

Here, when the state of the first power converter is the specific state, there is a concern that electric power required to cause the vehicle to travel is not supplied from the first power converter to the first electric motor. In this aspect, in the first control, it is possible to control the first power converter such that the state of the first power converter becomes the specific state (typically, the state of the first power converter is fixed to the specific state) when in the second determination the electronic control unit determines that the vehicle is stopped. Particularly, because it is possible to highly accurately determine in the second determination that the vehicle is stopped as described above, the first control is able to control the first power converter such that the state of the first power converter becomes the specific state when the vehicle is exactly stopped. That is, the first control is able to control the first power converter such that the state of the first power converter becomes the specific state at the timing at which there is no concern that the state of the first power converter does not influence running of the vehicle.

In the thus configured vehicle control device including the first control, the vehicle may further include a ground fault detector that detects a ground fault in an electrical system including the first electric motor. The electronic control unit may be configured to control the first power converter such that the state of the first power converter becomes the specific state when the electronic control unit has carried out the second determination that the vehicle is stopped and configured to control the ground fault detector such that the ground fault detector carries out detection of the ground fault when the state of the first power converter is the specific state.

In the thus configured vehicle control device, the ground fault detector is able to detect a ground fault in part or all of the electrical system including the first electric motor (for example, the electrical system from the power supply to the first electric motor via the power converter). The ground fault detector, typically, may detect whether there is a ground fault by detecting fluctuations in the state of the electrical system due to whether there is a ground fault in the electrical system with any method. For example, because of whether there is a ground fault in the electrical system, the impedance in the electrical system can fluctuate by the amount of the impedance of a ground fault path that is formed as a result of a ground fault. Thus, the ground fault detector may detect whether there is a ground fault by detecting fluctuations in the impedance (or fluctuations in the potential of the electrical system due to fluctuations in the impedance) with any method.

The electronic control unit may be particularly configured to control the ground fault detector such that the ground fault detector carries out detection of a ground fault when the state of the first power converter is the specific state in addition to control over the first power converter in the first control.

When the ground fault detector is carrying out detection of the ground fault, the state of the first power converter preferably does not fluctuate (in other words, the state of the first power converter is fixed). This is because there is a concern that the ground fault detector erroneously detects fluctuations in the state of the electrical system due to fluctuations in the state of the first power converter as fluctuations in the state of the electrical system due to a ground fault. In the first control, in order to control the first power converter such that the state of the first power converter does not fluctuate, it is preferable to highly accurately determine in the second determination whether the vehicle is stopped (for example, to reliably determine that the vehicle is stopped when the vehicle is actually stopped). Thus, because it is possible to highly accurately determine in the second determination whether the vehicle is stopped as described above, there is a relatively high possibility that the state of the first power converter is fixed (typically, the state of the first power converter is fixed to the specific state) while the ground fault detector is carrying out detection of the ground fault. Thus, the ground fault detector is able to suitably carry out detection of the ground fault.

In the vehicle control device, the electronic control unit may be configured to control the ground fault detector such that the ground fault detector carries out detection of the ground fault, and the electronic control unit may be configured to determine that the first electric motor is not stopped when a stop cancellation condition is satisfied in the vehicle after the detection is carried out. The stop cancellation condition may include a condition that the rotation speed of the first electric motor is higher than a second threshold or a condition that the stop operation is not being carried out.

In the vehicle control device, the electronic control unit may be configured to determine that the first electric motor is not stopped when the stop cancellation condition is satisfied. The electronic control unit may be configured to cancel the specific state and end the detection of the ground fault after determining that the first electric motor is not stopped.

In the vehicle control device according to the invention, the electronic control unit may be configured to carry out the second determination that the vehicle is stopped when a duration of a state is longer than or equal to a predetermined period, the state being where in the first determination the electronic control unit determines that the rotation speed of the first electric motor is lower than or equal to the first threshold and the stop operation is being carried out.

With the thus configured vehicle control device, it is possible to determine whether the vehicle is stopped in the second determination on the basis of the duration of the state where it is determined in the first determination that the rotation speed of the first electric motor is lower than or equal to the first threshold and the stop operation is being carried out. That is, in the second determination, when the duration is longer than or equal to the predetermined period, it may be determined that the vehicle is stopped. On the other hand, in the second determination, when the duration is not longer than or equal to the predetermined period, it may be determined that the vehicle is not stopped.

In the thus configured vehicle control device, by determining whether the vehicle is stopped, it is possible to further highly accurately determine in the second determination whether the vehicle is stopped. Particularly, in the second determination, it is possible to further highly accurately determine whether the vehicle is stopped, for example, when hunting is occurring in the rotation speed of the first electric motor (or the rotation speed of the first electric motor is instable). In terms of the point that it is possible to suppress frequent fluctuations in the determination result as to whether the vehicle is stopped because of the influence of hunting, or the like (in addition, frequent fluctuations in the state of the first power converter), the vehicle control device is able to implement suitable detection of a ground fault with the use of the ground fault detector as described above.

In the vehicle control device, the vehicle may further include a second electric motor coupled to the first electric motor via a power split mechanism. The electronic control unit may be configured to further determine in the first determination whether a rotation speed of the second electric motor is lower than or equal to a third threshold, and configured to carry out the second determination that the vehicle is stopped when the electronic control unit determines in the first determination that the rotation speed of the first electric motor is lower than or equal to the first threshold, the stop operation is being carried out and the rotation speed of the second electric motor is lower than or equal to the third threshold.

With the thus configured control device, the vehicle may include the plurality of electric motors. That is, the vehicle may include the second electric motor coupled to the first electric motor via the power split mechanism (for example, a planetary gear mechanism, or the like) in addition to the first electric motor. The rotation speed of the second electric motor does not need to be synchronized with the rotation speed of the drive shaft.

When the vehicle includes the second electric motor in this way, it may be further determined in the first determination whether the rotation speed of the second electric motor is lower than or equal to the third threshold. In the second determination, it may be determined whether the vehicle is stopped further on the basis of the determination result as to whether the rotation speed of the second electric motor is lower than or equal to the third threshold. As will be described in detail later with reference to the drawings, in the second determination, it may be determined whether the vehicle is stopped not on the basis of the determination result as to whether the rotation speed of the second electric motor is lower than or equal to the third threshold.

In this way, with the thus configured vehicle control device, in the second determination, it is possible to highly accurately determine whether the vehicle is stopped even when the vehicle includes the plurality of electric motors.

In the thus configured control device that controls the vehicle including the second electric motor, the second electric motor may be a three-phase alternating-current motor, the vehicle may include a pair of serially connected third switching element and fourth switching element in each of the three phases of the second electric motor, and the vehicle may further include a second power converter that converts direct-current power to alternating-current power, the direct-current power being supplied to the second electric motor. The electronic control unit may be configured to execute second control that controls the second power converter such that a state of the second power converter is set to a specific state where one of the set of third switching elements all and the set of fourth switching elements all are in an off state and at least one switching element of the other one of the set of third switching elements and the set of fourth switching elements is in an on state, when the electronic control unit has carried out the second determination that the vehicle is stopped.

With the thus configured vehicle control device, for a similar reason to that of the above-described control device including the first control, it is possible to control the second power converter in the second control such that the state of the second power converter becomes the specific state at the timing at which there is no concern that the state of the second power converter does not influence running of the vehicle.

In the vehicle control device, the vehicle may further include a ground fault detector that detects a ground fault in an electrical system including the second electric motor, and the electronic control unit may be configured to execute the second control that controls the second power converter such that the state of the second power converter becomes the specific state when the electronic control unit has determined that the second electric motor is stopped, and configured to control the ground fault detector such that the ground fault detector carries out detection of the ground fault when the state of the second power converter is the specific state.

In the vehicle control device, the electronic control unit may be configured to control the ground fault detector such that the ground fault detector carries out detection of the ground fault, and the electronic control unit may be configured to determine that the second electric motor is not stopped when a stop cancellation condition is satisfied in the vehicle after the detection is carried out. The stop cancellation condition may include a condition that the first electric motor is not stopped or a condition that the rotation speed of the second electric motor is higher than a fourth threshold. The stop cancellation condition may include a condition that the first electric motor is not stopped or a condition that an engine is not stopped. The stop cancellation condition may include a condition that the rotation speed of the first electric motor is higher than the second threshold, a condition that the rotation speed of the second electric motor is higher than the fourth threshold, or a condition that the stop operation that stops the vehicle is not being carried out.

In the vehicle control device, the electronic control unit may be configured to cancel the specific state and end the detection of the ground fault of the second electric motor when the stop cancellation condition is satisfied in the vehicle.

The above-described operation and advantages of the vehicle control device become apparent from embodiments that will be described below.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram that shows the configuration of a vehicle according to a first embodiment;

FIG. 2 is a flowchart that shows the flow of a stop determination operation according to the first embodiment;

FIG. 3 is a timing chart that shows a rotation speed of a motor generator, a brake depression force, whether a stop determination condition is satisfied and a stop determination result of the vehicle according to the first embodiment;

FIG. 4 is a block diagram that shows the configuration of a vehicle according to a second embodiment;

FIG. 5 is a flowchart that shows the flow of a first operation example of a stop determination operation according to the second embodiment;

FIG. 6 is a flowchart that shows the flow of a second operation example of the stop determination operation according to the second embodiment; and

FIG. 7 is a flowchart that shows the flow of a third operation example of the stop determination operation according to the second embodiment.

### DETAILED DESCRIPTION OF EMBODIMENTS

Hereinafter, first and second embodiments of a vehicle control device will be sequentially described.

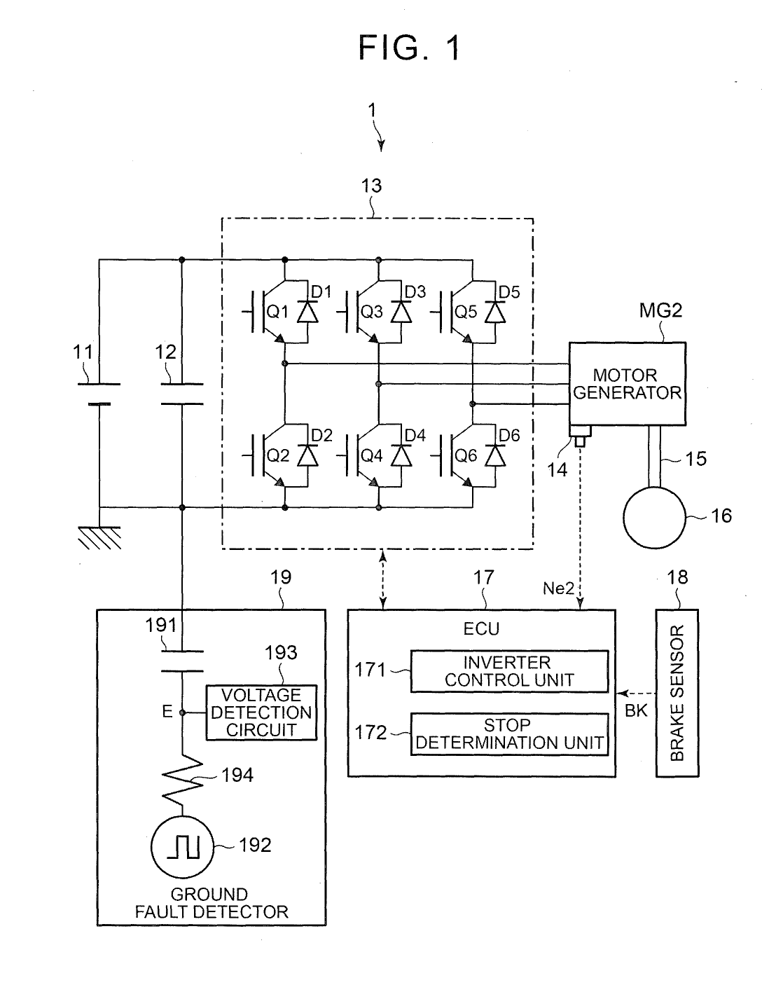

Initially, the first embodiment will be described with reference to FIG. 1 to FIG. 3. The configuration of a vehicle 1 according to the first embodiment will be described with reference to FIG. 1. FIG. 1 is a block diagram that shows the configuration of the vehicle 1 according to the first embodiment.

As shown in FIG. 1, the vehicle 1 includes a direct-current power supply 11, a smoothing capacitor 12, an inverter 13, a motor generator MG2, a rotation angle sensor 14, a drive shaft 15, a drive wheel 16, an electronic control unit (ECU) 17, a brake sensor 18 and a ground fault detector 19. The inverter 13 is one specific example of a “first power converter”. The motor generator MG2 is one specific example of a “first electric motor”. The ECU 17 is one specific example of a “control device for a vehicle”.

The direct-current power supply 11 is a rechargeable electrical storage device. The direct-current power supply 11 is, for example, a secondary battery (such as a nickel-metal hydride battery and a lithium ion battery) or a capacitor (such as an electric double layer capacitor and a large-capacitance capacitor).

The smoothing capacitor 12 is a voltage smoothing capacitor connected between the positive electrode line of the direct-current power supply 11 and the negative electrode line of the direct-current power supply 11.

The inverter 13 converts direct-current power (direct-current voltage), which is supplied from the direct-current power supply 11, to alternating-current power (three-phase alternating-current voltage). In order to convert direct-current power (direct-current voltage) to alternating-current power (three-phase alternating-current voltage), the inverter 13 includes a U-phase arm, a V-phase arm and a W-phase arm. The U-phase arm includes a positive-side switching element Q1 and a negative-side switching element Q2. The V-phase arm includes a positive-side switching element Q3 and a negative-side switching element Q4. The W-phase arm includes a positive-side switching element Q5 and a negative-side switching element Q6. The arms of the inverter 13 are connected in parallel with one another between the positive electrode line and the negative electrode line. The positive-side switching element Q1 and the negative-side switching element Q2 are connected in series with each other between the positive electrode line and the negative electrode line. The same applies to the positive-side switching element Q3 and the negative-side switching element Q4, and the positive-side switching element Q5 and the negative-side switching element Q6. A rectifier diode D1 is connected to the positive-side switching element Q1. The rectifier diode D1 flows current from the emitter terminal of the positive-side switching element Q1 to the collector terminal of the positive-side switching element Q1. Similarly, a rectifier diode D2 to a rectifier diode D6 are respectively connected to the negative-side switching element Q2 to the negative-side switching element Q6. A midpoint between the upper arm (that is, the positive-side switching element) and lower arm (that is, the negative-side switching element) of each of the three-phase arms in the inverter 13 is connected to a corresponding one of three-phase coils of the motor generator MG2. As a result, alternating-current power (three-phase alternating-current voltage) that is generated as a result of conversion operation of the inverter 13 is supplied to the motor generator MG2.

The motor generator MG2 is a three-phase alternating-current motor generator. The motor generator MG2 is driven so as to generate torque required to cause the vehicle 1 to travel. The torque generated by the motor generator MG2 is transmitted to the drive wheel 16 via the drive shaft 15 mechanically coupled to the rotary shaft of the motor generator MG2. The motor generator MG2 may regenerate (generate) electric power during braking of the vehicle 1.

The rotation angle sensor 14 detects the rotation speed Ne2 of the motor generator MG2 (that is, the rotation speed of the rotary shaft of the motor generator MG2). The rotation angle sensor 14 preferably directly detects the rotation speed Ne2 of the motor generator MG2. An example of the rotation angle sensor 14 is, for example, a resolver, such as a rotary encoder. The rotation angle sensor 14 preferably outputs the detected rotation speed Ne2 to the ECU 17.

The ECU 17 is an electronic control unit that controls the operation of the vehicle 1. In the first embodiment, the ECU 17 includes an inverter control unit 171 and a stop determination unit 172 as physical, logical or functional processing blocks. The inverter control unit 171 is one specific example of “first control device”. The stop determination unit 172 is one specific example of “first determination device” and “second determination device”.

The inverter control unit 171 is a processing block that controls the operation of the inverter 13. The inverter control unit 171 may control the operation of the inverter 13 by using a known control method. For example, the inverter control unit 171 may control the operation of the inverter 13 by using a pulse width modulation (PWM) control method.

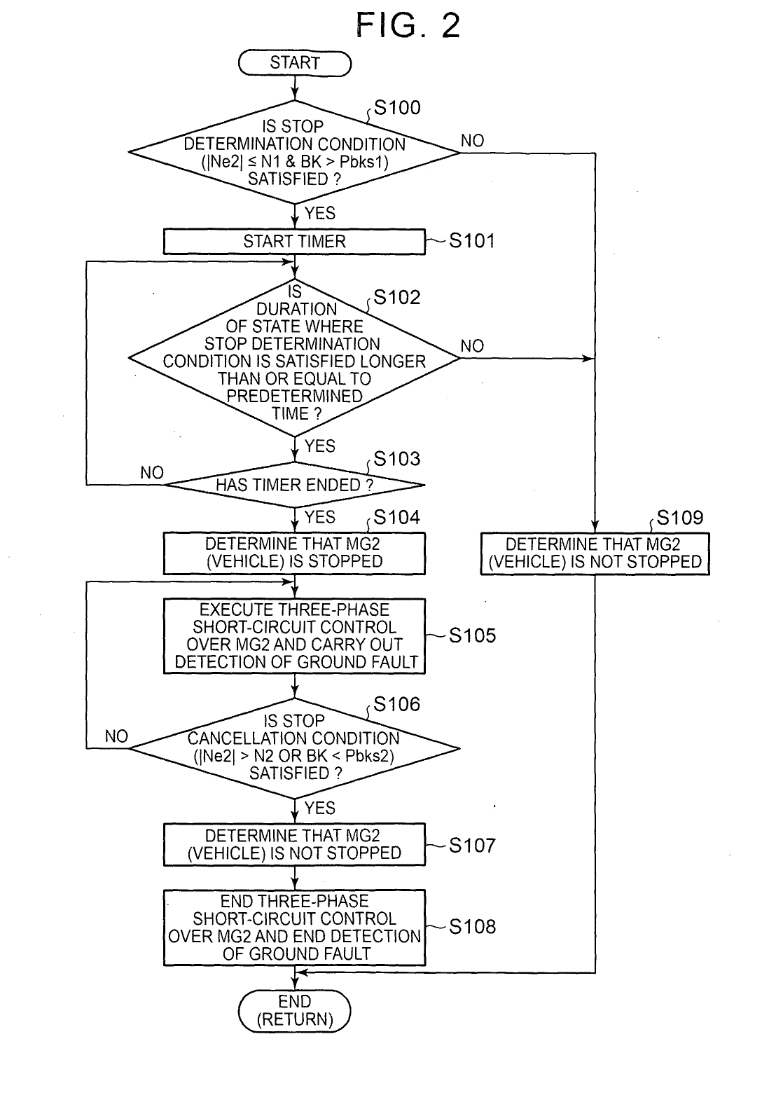

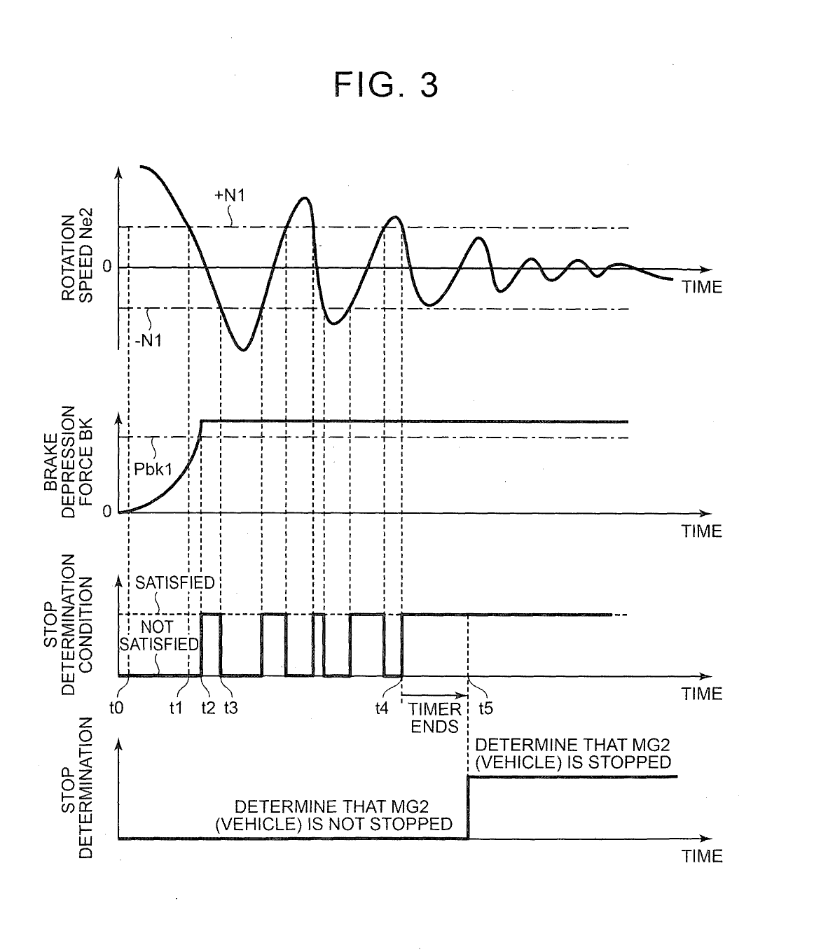

The stop determination unit 172 executes stop determination operation that determines whether the motor generator MG2 is stopped. The stop determination operation will be described in detail later (see FIG. 2 and FIG. 3), so the detailed description is omitted here.

Considering the fact that the drive shaft 15 of the vehicle 1 is coupled to the rotary shaft of the motor generator MG2, the rotation speed of the drive shaft 15 of the vehicle 1 synchronizes with the rotation speed Ne2 of the rotary shaft of the motor generator MG2. For example, the rotation speed of the drive shaft 15 of the vehicle 1 is directly proportional to the rotation speed Ne2 of the rotary shaft of the motor generator MG2. Thus, when the rotation speed Ne2 of the rotary shaft of the motor generator MG2 becomes zero as a result of a stop of the motor generator MG2, the rotation speed of the drive shaft 15 should also become zero. A state where the rotation speed of the drive shaft 15 is zero is substantially equivalent to a state where the vehicle 1 is stopped. Therefore, a stop of the motor generator MG2 substantially corresponds to a stop of the vehicle 1. The stop determination unit 172 may determine whether the vehicle 1 is stopped in addition to or instead of determination as to whether the motor generator MG2 is stopped.

The brake sensor 18 detects a brake depression force (that is, a parameter indicating a force depressing a foot brake) BK. The brake sensor 18 preferably outputs the detected brake depression force BK to the ECU 17.

The ground fault detector 19 carries out detection of a ground fault in an electrical system including the direct-current power supply 11, the smoothing capacitor 12, the inverter 13 and the motor generator MG2 (so-called motor driving system).

In order to carry out detection of a ground fault, the ground fault detector 19 includes a coupling capacitor 191, an oscillating circuit 192, a voltage detection circuit 193 and a resistor 194.

A method in which the ground fault detector 19 carries out detection of a ground fault is as follows. Initially, the oscillating circuit 192 outputs a pulse signal (or alternating-current signal) having a predetermined frequency. The voltage detection circuit 193 detects the voltage at a node E, which fluctuates because of the pulse signal. Here, if there occurs a ground fault in the electrical system, a ground fault path from the electrical system to a chassis ground (typically, the ground fault path is equivalent to a circuit formed of a resistor or a circuit in which a resistor and a capacitor are connected in parallel with each other) is formed. As a result, the pulse signal that is output from the oscillating circuit 192 is transmitted through a path to the resistor 194, the coupling capacitor 191 and the ground fault path. The voltage of the pulse signal at the node E receives influence on the impedance of the ground fault path (typically, the resistance value of the resistor included in the equivalent circuit of the ground fault path). Thus, when the voltage detection circuit 193 detects the voltage at the node E, it is possible to carry out detection of a ground fault.

### (1-2) Flow of Stop Determination Operation According to First Embodiment

Subsequently, the flow of the stop determination operation that is executed in the vehicle 1 according to the first embodiment (that is, the stop determination operation that is executed by the ECU 17) will be described with reference to FIG. 2. FIG. 2 is a flowchart that shows the flow of the stop determination operation according to the first embodiment.

As shown in FIG. 2, the stop determination unit 172 determines whether a predetermined stop determination condition is satisfied (step S100).

The stop determination condition includes a stop determination condition based on the rotation speed Ne2 of the motor generator MG2. In FIG. 2, as an example of the stop determination condition based on the rotation speed Ne2, the condition that the absolute value of the rotation speed Ne2 of the motor generator MG2 is lower than or equal to a predetermined threshold N1 (that is, the relationship |Ne2|≦N1 is satisfied) is used.

As described above, a stop of the motor generator MG2 corresponds to a stop of the vehicle 1. Thus, the predetermined threshold N1 for determining a stop of the motor generator MG2 may be set to an appropriate value on the basis of the rotation speed Ne2 of the motor generator MG2. The rotation speed Ne2 of the motor generator MG2 is observed in a state where the vehicle 1 is stopped. For example, where a “stop of the vehicle 1” means a state where the speed of the vehicle 1 is zero or substantially zero, the predetermined threshold N1 may be set to a value higher than or equal to the rotation speed Ne2 of the motor generator MG2. Here, the rotation speed Ne2 of the motor generator MG2 is observed in the case where the speed of the vehicle 1 is zero.

In addition, the stop determination condition includes a stop determination condition based on whether there is an operation that can stop the vehicle 1 (hereinafter, referred to as “stop operation” where appropriate). In FIG. 2, as an example of the stop determination condition based on whether there is the stop operation, the condition that the brake depression force BK is larger than a predetermined threshold Pbks1 (that is, the relationship BK>Pbks1 is satisfied) is used.

The stop operation is typically performed on the basis of a driver's intention (that is, driver's voluntary operation). However, the stop operation may be automatically performed irrespective of a driver's intention (for example, automatically under control of a controller, such as the ECU 17). A situation that the stop operation is automatically performed can occur in, for example, the vehicle 1 that executes automatic drive control (that is, control for autonomously causing the vehicle 1 to travel irrespective of whether there is a driver's operation).

The stop determination condition shown in FIG. 2 is only illustrative. Thus, a stop determination condition different from the stop determination condition shown in FIG. 2 may also be used. For example, as long as it is possible to distinguish a state where the vehicle 1 is stopped and a state where the vehicle 1 is not stopped from each other on the basis of a difference in the characteristics of the rotation speed Ne2, any condition that utilizes a difference in the characteristics of the rotation speed Ne2 may be used as the stop determination condition based on the rotation speed Ne2. Similarly, as long as it is possible to distinguish a state where the vehicle 1 is stopped and a state where the vehicle 1 is not stopped from each other on the basis of a difference in the characteristics of the stop operation, any condition that utilizes a difference in the characteristics of the stop operation may be used as the stop determination condition based on whether there is the stop operation.

The stop determination condition based on whether there is the stop operation is preferably a stop determination condition based on whether there is an operation that is directly intended to stop the vehicle 1. The operation that is directly intended to stop the vehicle 1 is, for example, an operation that can apply braking force to the vehicle 1 (for example, an action to operate a selected brake, such as a foot brake and a side brake) and an operation that is highly likely to be performed when the vehicle is stopped (for example, an action to shift a shift lever to a P range, or the like). Thus, for example, the condition that a selected brake is operated may be used as the stop determination condition based on whether there is the stop operation. Alternatively, for example, the condition that a braking force due to a selected brake is larger than a predetermined threshold (for example, the condition that the above-described brake depression force BK is larger than the predetermined threshold Pbks1) may be used as the stop determination condition based on whether there is the stop operation. Alternatively, for example, the condition that the range of the shift lever is the P range may be used as the stop determination condition based on whether there is the stop operation.

However, the stop determination condition based on whether there is the stop operation may be a stop determination condition based on whether there is an operation that is not an operation directly intended to stop the vehicle 1 but that can lead to a stop of the vehicle 1 as a result. The operation that can lead to a stop of the vehicle 1 is, for example, an operation that is highly likely to be performed in advance of a stop of the vehicle (for example, an operation to release the foot from the accelerator pedal). Thus, for example, the condition that the accelerator pedal is not operated may be used as the stop determination condition based on whether there is the stop operation.

Alternatively, the stop determination condition based on whether there is the stop operation may be a condition associated with whether there is another operation that occurs because of the stop operation. For example, another operation that occurs because of the stop operation is, for example, an operation to set a torque command value of creep to zero and an operation to set a torque command value of the motor generator MG2 to zero. Thus, for example, the condition that the torque command value of creep is zero or the condition that the torque command value of the motor generator MG2 is zero may be used as the stop determination condition based on whether there is the stop operation.

When it is determined that the stop determination condition is not satisfied as a result of determination of step S100 (No in step S100), the stop determination unit 172 determines that the motor generator MG2 is not stopped (step S109). Specifically, when it is determined that the absolute value of the rotation speed Ne2 of the motor generator MG2 is not lower than the predetermined threshold N1 (that is, |Ne2|>N1), the stop determination unit 172 determines that the motor generator MG2 is not stopped. Similarly, when it is determined that the brake depression force BK is not larger than the predetermined threshold Pbks1 (that is, BK Pbks1), the stop determination unit 172 determines that the motor generator MG2 is not stopped.

When it is determined that the motor generator MG2 is not stopped, the ECU 17 ends the operation. However, the ECU 17 may execute the operation from step S100 again.

On the other hand, when it is determined that the stop determination condition is satisfied as a result of determination of step S100 (Yes in step S100), the stop determination unit 172 starts a timer that measures a predetermined period (step S101).

After the stop determination unit 172 starts the timer, the stop determination unit 172 determines whether the state where the stop determination condition is satisfied is continuing (step S102).

When it is determined that the state where the stop determination condition is satisfied is not continuing as a result of determination of step S102 (No in step S102), the stop determination unit 172 determines that the motor generator MG2 is not stopped (step S109). That is, when it is determined that the stop determination condition is not satisfied before the timer ends, the stop determination unit 172 determines that the motor generator MG2 is not stopped. In other words, when it is determined that the duration of the state where the stop determination condition is satisfied is not longer than or equal to a predetermined period, the stop determination unit 172 determines that the motor generator MG2 is not stopped.

On the other hand, when it is determined that the state where the stop determination condition is satisfied is continuing as a result of determination of step S102 (Yes in step S102), the stop determination unit 172 executes the operation to determine whether the state where the stop determination condition is satisfied is continuing (step S102) repeatedly until the timer ends (step S103).

After that, when the timer ends (Yes in step S103), the stop determination unit 172 determines that the motor generator MG2 is stopped (step S104). That is, when it is determined that the stop determination condition has been satisfied in a period from the start of the timer to the end of the timer, the stop determination unit 172 determines that the motor generator MG2 is stopped. In other words, when it is determined that the duration of the state where the stop determination condition is satisfied is longer than or equal to the predetermined period, the stop determination unit 172 determines that the motor generator MG2 is stopped.

Here, the operation to determine whether the motor generator MG2 is stopped will be described by way of specific examples of the rotation speed Ne2 and brake depression force BK with reference to FIG. 3. FIG. 3 is a timing chart that shows the rotation speed Ne2, the brake depression force BK, whether the stop determination condition is satisfied and a stop determination result of the vehicle 1.

As shown in FIG. 3, the brake depression force BK increases as the foot brake starts being operated at time t0. With an increase in the brake depression force BK, the rotation speed Ne2 also decreases.

When the vehicle 1 intends to stop because of the operation of the foot brake, or the like, torsion tends to be generated in the drive shaft 15 of the vehicle 1. As a result, with the torsion of the drive shaft 15, hunting tends to occur in the rotation speed of the drive shaft 15. Considering the fact that the rotary shaft of the motor generator MG2 is coupled to the drive shaft 15, hunting also tends to occur in the rotation speed Ne2 of the motor generator MG2. FIG. 3 shows such hunting of the rotation speed Ne2 (in FIG. 3, upper limit fluctuations in the rotation speed Ne2, which gradually converge).

After that, at time t1, the absolute value of the rotation speed Ne2 becomes lower than or equal to the predetermined threshold N1. However, at the timing of time t1, the brake depression force BK is not larger than the predetermined threshold Pbk1. Thus, the stop determination condition is not satisfied.

After that, at time t2, the brake depression force BK becomes larger than the predetermined threshold Pbk1. Therefore, at time t2, the stop determination condition is satisfied. However, at the timing of time t2, the duration of the state where the stop determination condition is satisfied is not longer than or equal to the predetermined period, so the stop determination unit 172 does not determine that the motor generator MG2 is stopped.

After that, due to the influence of hunting, at time t3 that is the time before the predetermined period elapses from time t2 (that is, the time before the timer started at time t2 ends), the absolute value of the rotation speed Ne2 exceeds the predetermined threshold N1. That is, the stop determination condition is not satisfied at time t3. As a result, the stop determination unit 172 does not determine that the motor generator MG2 is stopped.

After that, before time t4, the absolute value of the rotation speed Ne2 becomes lower than or equal to the predetermined threshold N1, but the duration of the state where the stop determination condition is satisfied is not longer than or equal to the predetermined period. Thus, in this case, the stop determination unit 172 does not determine that the motor generator MG2 is stopped.

After that, at time t4, the absolute value of the rotation speed Ne2 becomes lower than or equal to the predetermined threshold N1 again. Therefore, at time t4, the stop determination condition is satisfied. However, at the timing of time t4, the duration of the state where the stop determination condition is satisfied is not longer than or equal to the predetermined period, so the stop determination unit 172 does not determine that the motor generator MG2 is stopped.

After that, at time t5 that is the time at which the predetermined period has elapsed from time t4 (that is, the time at which the timer started at time t2 ends), the stop determination condition still continues being satisfied. Therefore, in the example shown in FIG. 3, for the first time at the timing of time t5, the stop determination unit 172 determines that the motor generator MG2 is stopped.

Referring back to FIG. 2, when it is determined that the motor generator MG2 is stopped, the ECU 17 (or the other components, such as the ground fault detector 19) may execute an operation that should be executed while the motor generator MG2 is stopped. However, the ECU 17 (or the other components, such as the ground fault detector 19) does not have to execute a special operation even when it is determined that the motor generator MG2 is stopped.

In the first embodiment, when it is determined that the motor generator MG2 is stopped, the inverter control unit 171 controls the operation of the inverter 13 so as to execute three-phase short-circuit control (step S105). In the three-phase short-circuit control, the state of the motor generator MG2 is fixed in a three-phase short-circuit state. That is, the inverter control unit 171 controls the operation of the inverter 13 such that all the switching elements in one of the set of upper arms and the set of lower arms are in an on state and all the switching elements in the other one of the set of upper arms and the set of lower arms are in an off state. For example, the inverter control unit 171 may control the operation of the inverter 13 such that the positive-side switching element Q1, the positive-side switching element Q3 and the positive-side switching element Q5 are in an on state and the negative-side switching element Q2, the negative-side switching element Q4 and the negative-side switching element Q6 are in an off state.

However, in step S105, the inverter control unit 171 may control the operation of the inverter 13 so as to execute two-phase short-circuit control. In the two-phase short-circuit control, the state of the motor generator MG2 is fixed in a two-phase short-circuit state. That is, the inverter control unit 171 may control the operation of the inverter 13 such that any two switching elements in one of the set of upper arms and the set of lower arms are in an on state and the remaining one switching element in the one of the set of upper arms and the set of lower arms and all the switching elements in the other one of the set of upper arms and the set of lower arms are in an off state.

Alternatively, in step S105, the inverter control unit 171 may control the operation of the inverter 13 so as to execute control such that the state of the inverter 13 is fixed to a state where only any one of the six switching elements included in the inverter 13 is in an on state (while the remaining five switching elements are in an off state).

In addition, in the first embodiment, when it is determined that the motor generator MG2 is stopped, the ground fault detector 19 carries out detection of a ground fault in the electrical system while the three-phase short-circuit control is being executed (step S105). Because at least one of the six switching elements included in the inverter 13 is in the on state, the ground fault detector 19 is able to detect not only a ground fault of a direct-current portion (that is, a circuit portion on the direct-current power supply 11 side of the inverter 13 in the electrical system) but also a ground fault of an alternating-current portion (that is, a circuit portion on the motor generator MG2 side of the inverter 13 in the electrical system).

In parallel with the operation of step S105, the stop determination unit 172 determines whether a predetermined stop cancellation condition is satisfied (step S106). In the first embodiment, the stop cancellation condition, as well as the stop determination condition, includes both a stop cancellation condition based on the rotation speed Ne2 of the motor generator MG2 and a stop cancellation condition based on whether there is the stop operation. In FIG. 2, as an example of the stop cancellation condition based on the rotation speed Ne2, a condition that the absolute value of the rotation speed Ne2 of the motor generator MG2 is higher than a predetermined threshold N2 (that is, the relationship |Ne2|>N2 is satisfied) is used. The predetermined threshold N2 may be the same as the predetermined threshold N1 or may be different from the predetermined threshold N1. Similarly, in FIG. 2, as an example of the stop cancellation condition based on whether there is the stop operation, the condition that the brake depression force BK is smaller than a predetermined threshold Pbks2 (that is, the relationship BK<Pbks2 is satisfied) is used. The predetermined threshold Pbks2 may be the same as the predetermined threshold Pbks1 or may be different from the predetermined threshold Pbks1.

The stop cancellation condition shown in FIG. 2 is only one example. Thus, a stop cancellation condition different from the stop cancellation condition shown in FIG. 2 may also be used. The stop cancellation condition may be determined as needed in terms of a similar viewpoint to that of the stop determination condition.

The stop determination unit 172 may determine in step S106 whether the stop determination condition is satisfied in addition to or instead of determination as to whether the stop cancellation condition is satisfied. In this case, when it is determined that the stop determination condition is not satisfied, the subsequent operation may be executed in a similar mode to that in the case where the stop cancellation condition is satisfied. On the other hand, when it is determined that the stop determination condition is satisfied, the subsequent operation may be executed in a similar mode to that in the case where the stop cancellation condition is not satisfied.

When it is determined that the stop cancellation condition is not satisfied as a result of determination of step S106 (No in step S106), the inverter control unit 171 continues to control the operation of the inverter 13 so as to continue executing three-phase short-circuit control. Similarly, the ground fault detector 19 continues to carry out detection of a ground fault in the electrical system.

On the other hand, when it is determined that the stop cancellation condition is satisfied as a result of determination of step S106 (Yes in step S106), the stop determination unit 172 determines that the motor generator MG2 is not stopped (step S107). In this case, the inverter control unit 171 may control the operation of the inverter 13 so as not to execute the three-phase short-circuit control in which the state of the motor generator MG2 is fixed to the three-phase short-circuit state (step S108). Similarly, the ground fault detector 19 ends detection of a ground fault in the electrical system (step S108).

After that, the ECU 17 ends the operation. However, the ECU 17 may execute the operation from step S100 again.

As described above, in the first embodiment, the stop determination unit 172 is able to determine whether the motor generator MG2 (or the vehicle 1) is stopped on the basis of both the stop determination condition based on the rotation speed Ne2 of the motor generator MG2 and the stop determination condition based on whether there is the stop operation. Where an existing stop determination unit that determines whether the vehicle 1 is stopped on the basis of only the stop determination condition based on the rotation speed of the engine is regarded as a first comparative embodiment, the stop determination unit 172 is able to more highly accurately determine whether the motor generator MG2 (or the vehicle 1) is stopped than the stop determination unit 172a according to the first comparative embodiment. In addition, where an existing stop determination unit that determines whether the motor generator MG2 (or the vehicle 1) is stopped on the basis of only the stop determination condition based on the rotation speed Ne2 of the motor generator MG2 is regarded as a second comparative embodiment, the stop determination unit 172 is able to more highly accurately determine whether the motor generator MG2 (or the vehicle 1) is stopped than the stop determination unit 172b according to the second comparative embodiment. Hereinafter, the reason will be described.

Initially, the first comparative embodiment will be described in detail. The stop determination unit 172a according to the first comparative embodiment, which determines that the vehicle 1 is stopped in the case where the rotation speed of the engine, instead of the rotation speed Ne2 of the motor generator MG2, is lower than or equal to a predetermined threshold, will be described. The rotation speed of the engine is typically calculated from the crank angle of the engine instead of being detected by a detection mechanism that directly detects the rotation speed. The crank angle of the engine is output from a crank angle sensor installed in the engine. However, the accuracy of the rotation speed of the engine, which is calculated from the crank angle, is mostly lower than the accuracy of the rotation speed Ne2 of the motor generator MG2, which is detected by the rotation angle sensor 14 (that is, the detection mechanism that directly detects the rotation speed Ne2 of the motor generator MG2). Therefore, there is a concern that the stop determination unit 172a according to the first comparative embodiment erroneously determines that the vehicle 1 is stopped because of the accuracy error, or the like, of the rotation speed of the engine, which is calculated from the crank angle, although the vehicle 1 is not stopped. Alternatively, there is a concern that the stop determination unit 172a according to the first comparative embodiment erroneously determines that the vehicle 1 is not stopped although the vehicle 1 is stopped.

In contrast, the stop determination unit 172 according to the first embodiment is able to determine whether the motor generator MG2 (or the vehicle 1) is stopped on the basis of the rotation speed Ne2 of the motor generator MG2, which is detected by the rotation angle sensor 14. Considering that the accuracy of the rotation speed Ne2 of the motor generator MG2, which is detected by the rotation angle sensor 14, is mostly higher than the accuracy of the rotation speed of the engine, which is calculated from the crank angle, the stop determination unit 172 according to the first embodiment is able to relatively highly accurately determine whether the motor generator MG2 (or the vehicle 1) is stopped as compared to the stop determination unit 172a according to the first comparative embodiment.

Next, the second comparative embodiment will be described in detail. The stop determination unit 172b according to the second comparative embodiment, which determines that the motor generator MG2 (or the vehicle 1) is stopped in the case where the rotation speed Ne2 of the motor generator MG2 is lower than or equal to the predetermined threshold N1 without determining whether there is the stop operation, will be described. The stop determination unit 172b according to the second comparative embodiment is also considered to be able to relatively highly accurately determine whether the vehicle 1 is stopped in comparison with the stop determination unit 172a according to the first comparative embodiment. However, the rotation speed Ne2 of the motor generator MG2, which is detected by the rotation angle sensor 14, can be instable (that is, can fluctuate) upon reception of the influence of noise, or the like, that occurs in the rotation angle sensor 14. For example, although the actual rotation speed of the motor generator MG2 is zero, the rotation speed Ne2 of the motor generator MG2, which is detected by the rotation angle sensor 14, can be a numeric value other than zero. Thus, there is a concern that, in some cases, the stop determination unit 172b according to the second comparative embodiment erroneously determines that the motor generator MG2 (or the vehicle 1) is stopped although the motor generator MG2 (or the vehicle 1) is not stopped. Alternatively, there is a concern that, in some cases, the stop determination unit 172b according to the second comparative embodiment erroneously determines that the motor generator MG2 (or the vehicle 1) is not stopped although the motor generator MG2 (or the vehicle 1) is stopped.

In contrast, the stop determination unit 172 is able to determine whether the motor generator MG2 (or the vehicle 1) is stopped on the basis of not only the rotation speed Ne2 of the motor generator MG2 but also whether there is the stop operation. When the stop operation is being carried out, there is a further higher possibility that the motor generator MG2 (or the vehicle 1) is stopped. Therefore, the stop determination unit 172 according to the first embodiment is able to relatively highly accurately determine whether the motor generator MG2 (or the vehicle 1) is stopped as compared to the stop determination unit 172b according to the second comparative embodiment.

In addition, the stop determination unit 172 is allowed to determine that the motor generator MG2 (or the vehicle 1) is stopped when it is determined that the duration of the state where the stop determination condition is satisfied is longer than or equal to the predetermined period. Thus, the stop determination unit 172 is able to further highly accurately determine whether the motor generator MG2 (or the vehicle 1) is stopped even when hunting is occurring in the rotation speed Ne2 of the motor generator MG2 (or the rotation speed Ne2 of the motor generator MG2 is instable).

Specifically, when hunting is occurring in the rotation speed of the motor generator MG2, the state where the rotation speed Ne2 is lower than or equal to the predetermined threshold N1 and the state where the rotation speed Ne2 is not lower than or equal to the predetermined threshold N1 appear alternately in a short period of time. If it is merely determined that the motor generator MG2 (or the vehicle 1) is stopped in the case where the rotation speed Ne2 is lower than or equal to the predetermined threshold N1 in such a situation, there is a high possibility that the determination result as to whether the motor generator MG2 (or the vehicle 1) is stopped frequently fluctuates.

In contrast, in the first embodiment, the stop determination unit 172 is allowed to determine that the motor generator MG2 (or the vehicle 1) is not stopped in the case where it is determined that the rotation speed Ne2 is lower than or equal to the predetermined threshold N1 only in a short period of time because of hunting, or the like. On the other hand, the stop determination unit 172 is allowed to determine that the motor generator MG2 (or the vehicle 1) is stopped when it is determined that the duration of the rotation speed Ne2 is lower than or equal to the predetermined threshold N1 is longer than or equal to a certain time because of convergence of hunting, or the like. Thus, the stop determination unit 172 is able to suitably determine whether the motor generator MG2 (or the vehicle 1) is stopped while suppressing frequent fluctuations in determination result as to whether the motor generator MG2 (or the vehicle 1) is stopped because of the influence of hunting, or the like.

In addition, the inverter control unit 171 according to the first embodiment controls the inverter 13 so as to execute three-phase short-circuit control while it is determined that the motor generator MG2 (or the vehicle 1) is stopped. While the three-phase short-circuit control is being executed, there is a possibility that torque required to cause the vehicle 1 to travel cannot be supplied from the inverter 13 to the motor generator MG2. Thus, the inverter control unit 171 preferably controls the inverter 13 so as to execute three-phase short-circuit control while the motor generator MG2 (or the vehicle 1) is stopped. Conversely, if the three-phase short-circuit control is executed while the motor generator MG2 (or the vehicle 1) is not stopped, there is a concern that the three-phase short-circuit control influences running of the vehicle 1. Thus, the inverter control unit 171 preferably controls the inverter 13 so as not to execute three-phase short-circuit control while the motor generator MG2 (or the vehicle 1) is not stopped. Thus, in the first embodiment, as described above, the stop determination unit 172 is able to highly accurately determine whether the motor generator MG2 (or the vehicle 1) is stopped, so the inverter control unit 171 is able to control the inverter 13 so as to execute three-phase short-circuit control exactly while the motor generator MG2 (or the vehicle 1) is stopped. That is, the inverter control unit 171 is able to control the inverter 13 so as to execute three-phase short-circuit control at the timing at which there is no concern that the three-phase short-circuit control influences running of the vehicle 1.

In addition, the ground fault detector 19 according to the first embodiment is able to carry out detection of a ground fault while it is determined that the motor generator MG2 (or the vehicle 1) is stopped (in other words, while the inverter 13 is controlled so as to execute three-phase short-circuit control). If the state of the inverter 13 fluctuates while the ground fault detector 19 is carrying out detection of a ground fault, there is a concern that the state in the electrical system (for example, the impedance of a path including the above-described ground fault path) fluctuates because of fluctuations in the state of the inverter 13. As a result, there is a concern that the ground fault detector 19 erroneously recognizes state fluctuations due to fluctuations in the state of the inverter 13 (for example, the above-described fluctuations in the voltage at the node E) as state fluctuations due to a ground fault. Thus, in terms of improvement in the accuracy of carrying out detection of a ground fault with the use of the ground fault detector 19, the state of the inverter 13 is preferably fixed to the three-phase short-circuit state (or another state including the two-phase short-circuit state) while the ground fault detector 19 is carrying out detection of a ground fault.

Here, when the accuracy of determination as to whether the motor generator MG2 (or the vehicle 1) is stopped is relatively low, there is a high possibility that the result of determination as to whether the motor generator MG2 (or the vehicle 1) is stopped frequently fluctuates because of the above-described noise, hunting, or the like, as compared to the case where the determination accuracy is relatively high. As a result, there is a high possibility that the state of the inverter 13 frequently fluctuates because of the fluctuations in the result of determination as to whether the motor generator MG2 (or the vehicle 1) is stopped. As a result, there is a concern that the period in which the state of the inverter 13 is fixed to the three-phase short-circuit state becomes shorter than the period required to carry out detection of a ground fault with the use of the ground fault detector 19.

For such reasons, when it is highly accurately determined whether the motor generator MG2 (or the vehicle 1) is stopped, the state of the inverter 13 is easily fixed to the three-phase short-circuit state. Thus, in the first embodiment, as described above, the stop determination unit 172 is able to highly accurately determine whether the motor generator MG2 (or the vehicle 1) is stopped. Therefore, while the ground fault detector 19 is detecting a ground fault, the state of the inverter 13 is relatively highly likely to be fixed (typically, the state of the inverter 13 is fixed to a specific state). Thus, the ground fault detector 19 is able to suitably carry out detection of a ground fault.

In the above description, the vehicle 1 includes the single motor generator MG2. Instead, the vehicle 1 may include a plurality of the motor generators MG2. In this case, the vehicle 1 preferably includes the inverter 13 and the rotation angle sensor 14 for each motor generator MG2. In this case, the ECU 17 may execute the above-described stop determination operation independently for each motor generator MG2.

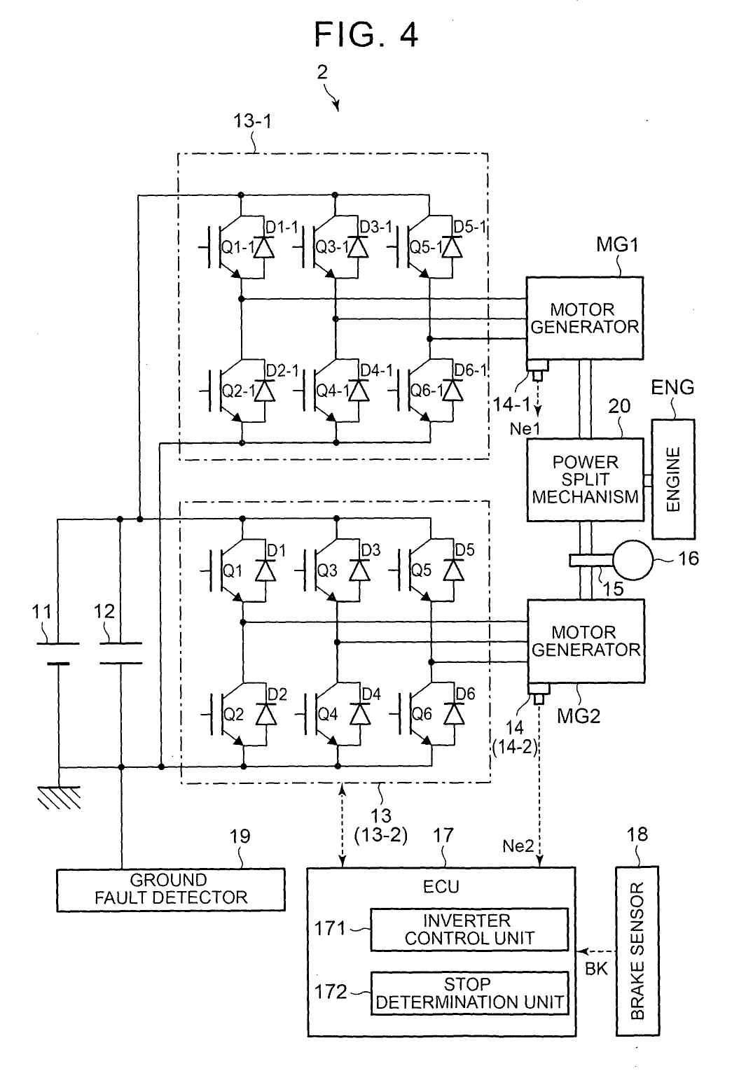

Next, a second embodiment will be described with reference to FIG. 4 to FIG. 6. Like reference numerals and step numbers denote similar components and operations to those of vehicle 1 according to the first embodiment, and the detailed description thereof is omitted.

### (2-1) Configuration of Vehicle According to Second Embodiment

Initially, the configuration of a vehicle 2 according to the second embodiment will be described with reference to FIG. 4. FIG. 4 is a block diagram that shows the configuration of the vehicle 2 according to the second embodiment.

As shown in FIG. 4, the vehicle 2 according to the second embodiment differs from the vehicle 1 according to the first embodiment in that the vehicle 2 further includes an engine ENG, a motor generator MG1, an inverter 13-1, a rotation angle sensor 14-1 and a power split mechanism 20. In addition, the vehicle 2 according to the second embodiment differs from the vehicle 1 according to the first embodiment in that the operation of the stop determination unit 172 is different. The other components of the vehicle 2 according to the second embodiment are the same as the other components of the vehicle 1 according to the first embodiment. However, for the sake of convenience of description, in the second embodiment, the inverter 13 according to the first embodiment is referred to as the inverter 13-2, and the rotation angle sensor 14 according to the first embodiment is referred to as the rotation angle sensor 14-2. For simplification of the drawings, the detailed configuration of the ground fault detector 19 is omitted; however, the ground fault detector 19 according to the second embodiment is the same as the ground fault detector 19 according to the first embodiment.

The inverter 13-1 is connected in parallel with the inverter 13-2. The inverter 13-1 converts alternating-current power (three-phase alternating-current voltage), generated through regenerative power generation by the motor generator MG1, to direct-current power (direct-current voltage). As a result, the direct-current power supply 11 is charged with direct-current power (direct-current voltage) generated as a result of conversion operation by the inverter 13-1. Because the configuration of the inverter 13-1 is the same as the configuration of the inverter 13-2, the detailed description of the configuration of the inverter 13-1 is omitted.

The motor generator MG1 is a three-phase alternating-current motor generator. The motor generator MG1 regenerates electric power (generates electric power) during braking of the vehicle 1. The motor generator MG1 may be driven so as to generate torque required to cause the vehicle 2 to travel.

The rotation angle sensor 14-1 detects the rotation speed Ne1 of the motor generator MG1 (that is, the rotation speed of the rotary shaft of the motor generator MG1). The rotation angle sensor 14-1 may be the same as the rotation angle sensor 14-2.

The engine ENG is an internal combustion engine, such as a gasoline engine, and functions as a main power source of the vehicle 2.

The power split mechanism 20 is a planetary gear mechanism that includes a sun gear, a planetary carrier, pinion gears and a ring gear (which are not shown). The power split mechanism 20 mainly splits the power of the engine ENG to two lines (that is, a power line to be transmitted to the motor generator MG1 and a power line to be transmitted to the drive shaft 15).

In the second embodiment, an example in which the vehicle 2 employs a so-called split (power split)-type hybrid system (for example, Toyota hybrid system (THS)) will be described. Instead, the vehicle 2 may employ a series or parallel hybrid system.

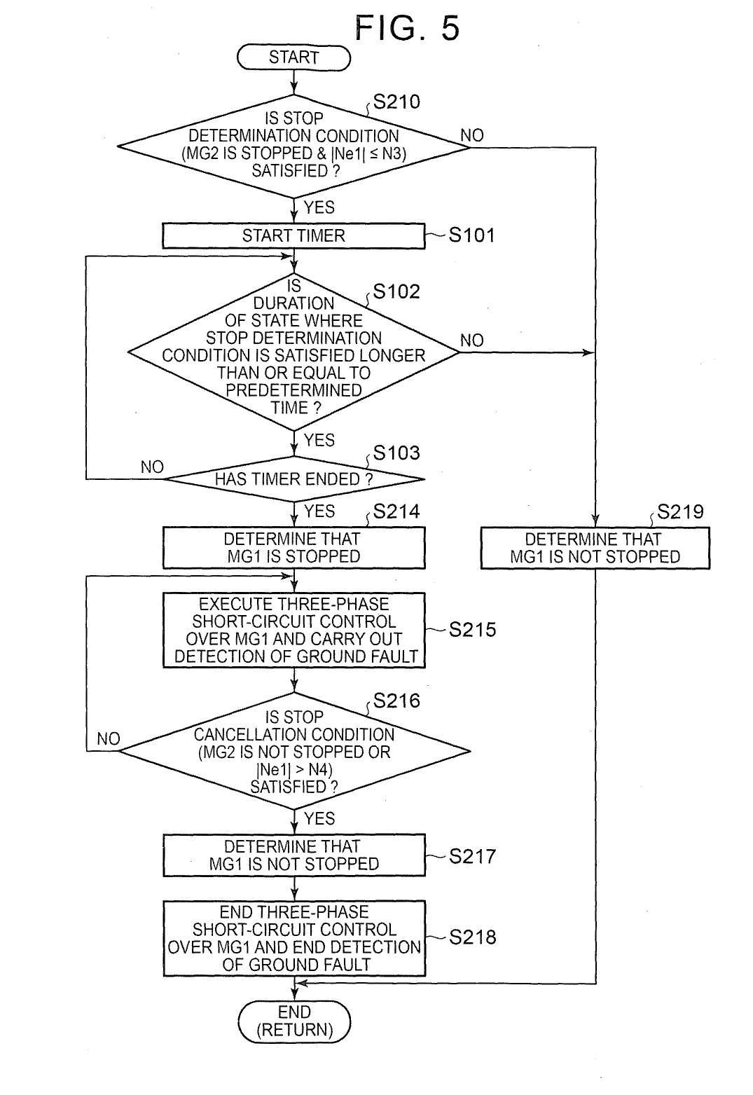

Subsequently, the flow of stop determination operation that is executed by the vehicle 2 according to the second embodiment (that is, the stop determination operation that is executed by the ECU 17) will be described with reference to FIG. 5 to FIG. 7. Hereinafter, first to third operation examples will be illustrated as the stop determination operation that is executed in the vehicle 2 according to the second embodiment.

First, the flow of the first operation example of the stop determination operation according to the second embodiment will be described with reference to FIG. 5. FIG. 5 is a flowchart that shows the flow of the first operation example of the stop determination operation according to the second embodiment.

The first operation example is an operation to determine whether the motor generator MG1 is stopped, and is an operation that is executed in parallel with or before or after the above-described stop determination operation according to the first embodiment.

Specifically, as shown in FIG. 5, the stop determination unit 172 determines whether a predetermined stop determination condition is satisfied (step S210).

The stop determination condition of the first operation example includes a stop determination condition based on the result of the stop determination operation according to the first embodiment (that is, the result of determination as to whether the motor generator MG2 is stopped). In FIG. 5, as an example of the stop determination condition based on the result of the stop determination operation according to the first embodiment, the condition that it is determined through the stop determination operation according to the first embodiment that the motor generator MG2 (or the vehicle 1) is stopped is used.

In addition, the stop determination condition of the first operation example includes a stop determination condition based on the rotation speed Ne1 of the motor generator MG1. In FIG. 5, as an example of the stop determination condition based on the rotation speed Ne1, the condition that the absolute value of the rotation speed Ne1 of the motor generator MG1 is lower than or equal to a predetermined threshold N3 (that is, the relationship |Ne1|≦N3 is satisfied) is used. The predetermined threshold N3 may be the same as the predetermined value N1 according to the first embodiment or may be different from the predetermined value N1. The stop determination condition shown in FIG. 5 is only one example, and may be modified as needed in terms of a similar viewpoint to that of the first embodiment.

When it is determined that the stop determination condition is not satisfied as a result of determination of step S210 (No in step S210), the stop determination unit 172 determines that the motor generator MG1 is not stopped (step S219).

On the other hand, when it is determined that the stop determination condition is satisfied as a result of determination of step S210 (Yes in step S210), the stop determination unit 172, as in the case of the first embodiment, determines whether the duration of the state where the stop determination condition is satisfied is longer than or equal to the predetermined time (from step S101 to step S103).

When it is determined that the duration of the state where the stop determination condition is satisfied is not longer than or equal to the predetermined time as a result of determination of step S102 and step S103 (No in step S102), the stop determination unit 172 determines that the motor generator MG1 is not stopped (step S219).

On the other hand, when it is determined that the duration of the state where the stop determination condition is satisfied is longer than or equal to the predetermined time as a result of determination of step S102 and step S103 (Yes in step S102 and Yes in step S103), the stop determination unit 172 determines that the motor generator MG1 is stopped (step S214). This is because, when the rotation speed Ne1 of the motor generator MG1 is relatively low (for example, several rpm to several tens of rpm) under a situation that the motor generator MG2 is stopped, the rotation speed of the engine ENG should also relatively decrease (for example, becomes about several rpm) from an operation nomograph of the motor generators MG1, MG2 and the engine ENG. However, considering that it is almost impossible that the rotation speed of the engine ENG becomes several rpm in accordance with the specifications of the engine ENG, when the rotation speed Ne1 of the motor generator MG1 is relatively low under a situation that the motor generator MG2 is stopped, the rotation speed of the engine ENG is estimated to be substantially zero. That is, when the rotation speed Ne1 of the motor generator MG1 is relatively low under a situation that the motor generator MG2 is stopped, it is estimated that the engine ENG is stopped. As a result, the motor generator MG1 is also estimated to be substantially stopped from the operation nomograph.

After that, when it is determined that the motor generator MG1 is stopped, the ECU 17 (or another component, such as the ground fault detector 19) may execute the operation that should be executed while the motor generator MG1 is stopped. In the first operation example, when it is determined that the motor generator MG1 is stopped, the inverter control unit 171 controls the operation of the inverter 13-1 so as to execute three-phase short-circuit control (step S215). In the three-phase short-circuit control, the state of the motor generator MG1 is fixed in a three-phase short-circuit state. However, in the first operation example, as well as the first embodiment, the inverter control unit 171 may control the operation of the inverter 13-1 so as to execute control in which the state of the motor generator MG1 is fixed to a state other than the three-phase short-circuit state. In addition, when it is determined that the motor generator MG1 is stopped, the ground fault detector 19 carries out detection of a ground fault in the electrical system while the three-phase short-circuit control is being executed (step S215).

In the first operation example, the motor generator MG2 is stopped, while there can occur a situation that it is determined that the motor generator MG1 is not stopped. In this case, there is a concern that the state of the inverter 13-1 is not fixed, so the ground fault detector 19 does not need to carry out detection of a ground fault in the electrical system.

In parallel with the operation of step S215, the stop determination unit 172 determines whether the predetermined stop cancellation condition is satisfied (step S216). In the first operation example, the stop cancellation condition, as well as the stop determination condition, includes both a stop cancellation condition based on the result of stop determination operation according to the first embodiment and a stop cancellation condition based on the rotation speed Ne1 of the motor generator MG1. In FIG. 5, as an example of the stop cancellation condition based on the result of the stop determination operation according to the first embodiment, the condition that it is determined through the stop determination operation according to the first embodiment that the motor generator MG2 (or the vehicle 1) is not stopped is used. In FIG. 5, as an example of the stop cancellation condition based on the rotation speed Ne1, the condition that the absolute value of the rotation speed Ne1 of the motor generator MG1 is higher than a predetermined threshold N4 (that is, the relationship |Ne1|>N4 is satisfied) is used. The predetermined threshold N4 may be the same as the predetermined threshold N2 according to the first embodiment or may be different from the predetermined threshold N2. The stop cancellation condition shown in FIG. 5 is only illustrative, and may be modified as needed in terms of a similar viewpoint to that of the first embodiment.

When it is determined that the stop cancellation condition is not satisfied as a result of determination of step S216 (No in step S216), the inverter control unit 171 continues to control the operation of the inverter 13-1 so as to continue executing three-phase short-circuit control. Similarly, the ground fault detector 19 continues to carry out detection of a ground fault in the electrical system.

On the other hand, when it is determined that the stop cancellation condition is satisfied as a result of determination of step S216 (Yes in step S216), the stop determination unit 172 determines that the motor generator MG1 is not stopped (step S217). In this case, the inverter control unit 171 may control the operation of the inverter 13-1 so as not to execute three-phase short-circuit control in which the state of the motor generator MG1 is fixed to the three-phase short-circuit state (step S218). Similarly, the ground fault detector 19 ends detection of a ground fault in the electrical system (step S218).

As described above, according to the first operation example of the second embodiment as well, similar advantageous effects to the various advantageous effects obtained in the first embodiment are suitably obtained. In addition, in the first operation example of the second embodiment, the stop determination unit 172 is able to highly accurately determine whether the vehicle 2 and each of the motor generator MG1 and the motor generator MG2 are stopped even when the vehicle 2 includes the plurality of motor generators MG1, MG2.

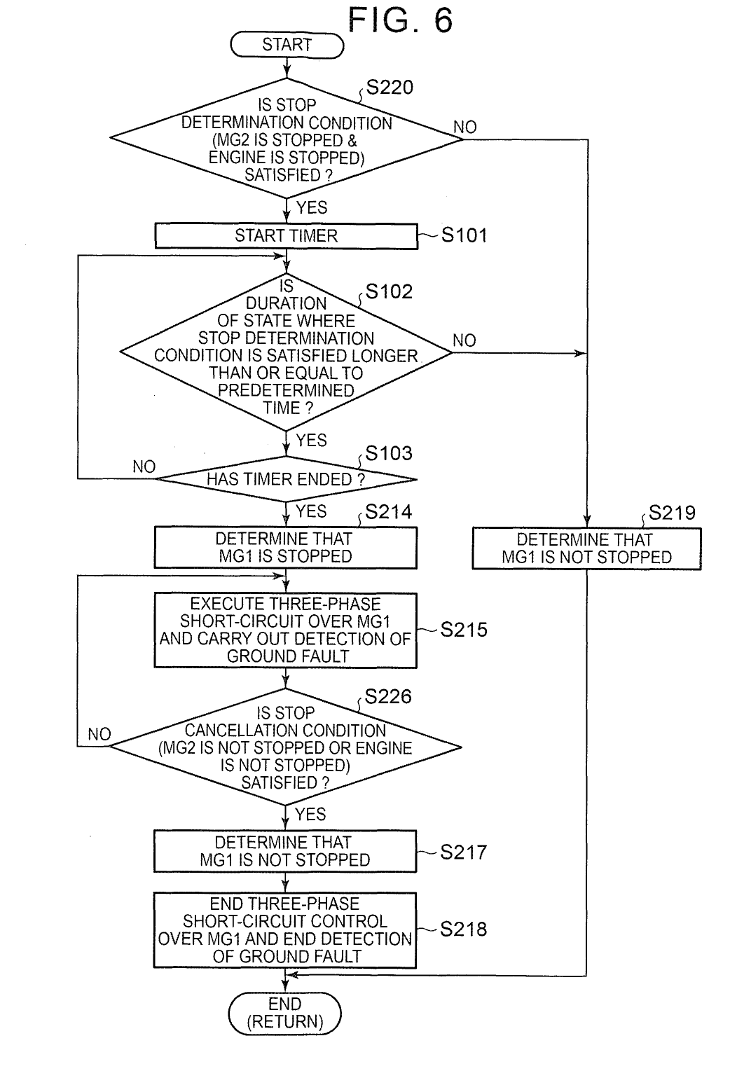

Next, the flow of the second operation example of the stop determination operation according to the second embodiment will be described with reference to FIG. 6. FIG. 6 is a flowchart that shows the flow of the second operation example of the stop determination operation according to the second embodiment.

The second operation example, as well as the first operation example, is also an operation to determine whether the motor generator MG1 is stopped, and is an operation that is executed in parallel with or before or after the above-described stop determination operation according to the first embodiment.

Specifically, the second operation example differs from the first operation example in that the stop determination condition and the stop cancellation condition are different (step S220 and step S226). The other operation of the second operation example may be the same as the other operation of the first operation example.

Specifically, the stop determination condition according to the second operation example includes a stop determination condition based on an operation situation of the engine ENG (for example, a stop determination condition that the engine ENG is stopped) instead of the stop determination condition based on the rotation speed Ne1 of the first operation example. Similarly, the stop cancellation condition according to the second operation example includes a stop cancellation condition based on an operation situation of the engine ENG (for example, a stop cancellation condition that the engine ENG is not stopped) instead of the stop cancellation condition based on the rotation speed Ne1 of the first operation example.

As described in the first operation example, when the engine ENG is stopped under a situation that the motor generator MG2 is stopped, it is estimated that the motor generator MG1 is also substantially stopped. Thus, in the second operation example, the stop determination unit 172 is able to suitably determine whether the motor generator MG1 is stopped even when the stop determination condition and the stop cancellation condition, based on the operation situation of the engine ENG, are used. That is, in the second operation example as well, similar advantageous effects to the various advantageous effects obtained in the first operation example, are suitably obtained.

The stop determination unit 172 may determine whether the engine ENG is stopped on the basis of the rotation speed of the engine ENG For example, the stop determination unit 172 may determine that the engine ENG is stopped when the rotation speed of the engine ENG is lower than or equal to a predetermined threshold. Alternatively, the stop determination unit 172 may determine whether the engine ENG is stopped on the basis of another parameter or signal that defines the operation of the engine ENG.

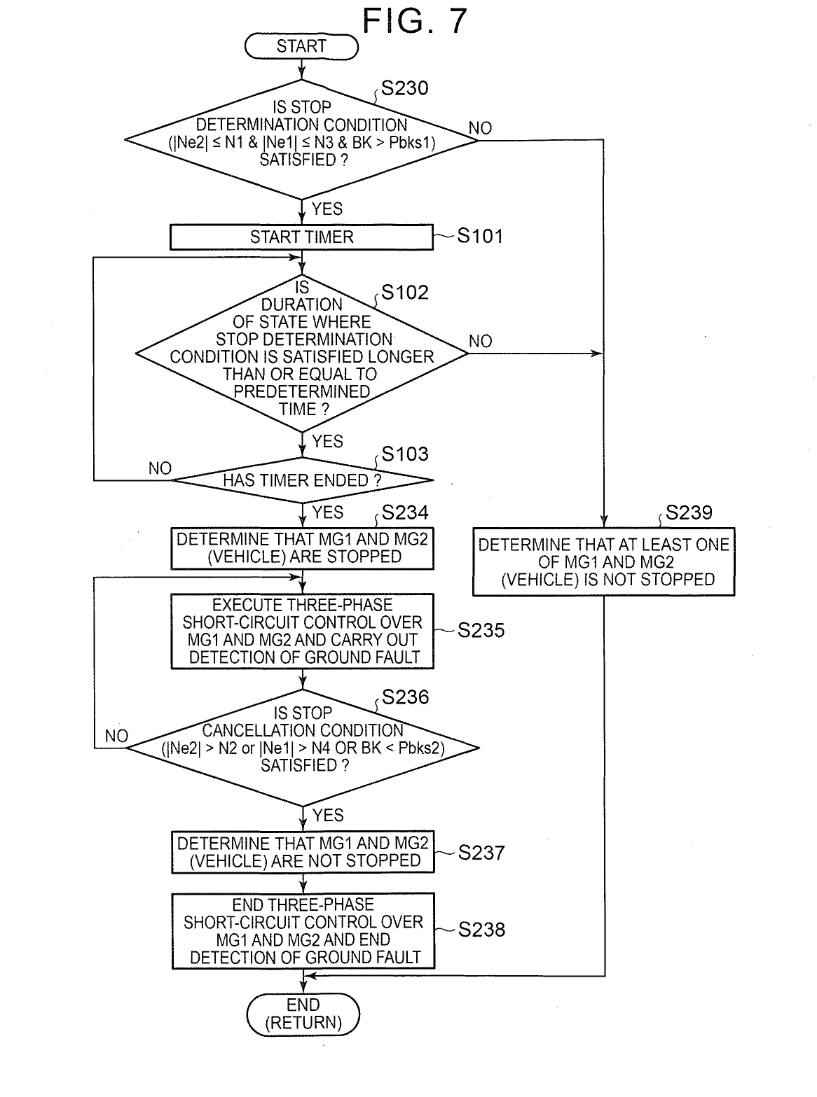

Next, the flow of the third operation example of the stop determination operation according to the second embodiment will be described with reference to FIG. 7. FIG. 7 is a flowchart that shows the flow of the third operation example of the stop determination operation according to the second embodiment.

The above-described first operation example and second operation example are operations to determine whether the motor generator MG1 is stopped and operations that are executed in parallel with or before or after the above-described stop determination operation according to the first embodiment. On the other hand, the third operation example is an operation to collectively determine whether the motor generator MG1 and the motor generator MG2 (or the vehicle 1) are stopped. Thus, the ECU 17 does not need to execute the above-described stop determination operation according to the first embodiment when the third operation example is executed.

Specifically, as shown in FIG. 7, the stop determination unit 172 determines whether a predetermined stop determination condition is satisfied (step S230). The stop determination condition according to the third operation example includes the stop determination condition according to the first embodiment (that is, the stop determination condition based on the rotation speed Ne2 of the motor generator MG2 and the stop determination condition based on whether there is the stop operation). In addition, the stop determination condition according to the third operation example includes a stop determination condition based on the rotation speed Ne1 of the motor generator MG1 (that is, part of the stop determination condition according to the first operation example). However, the stop determination condition according to the third operation example may include the stop determination condition based on the operation situation of the engine ENG (that is, part of the stop determination condition according to the second operation example) in addition to or instead of the stop determination condition based on the rotation speed Ne1 of the motor generator MG1 (that is, part of the stop determination condition according to the first operation example).

When it is determined that the stop determination condition is not satisfied as a result of determination of step S230 (No in step S230), the stop determination unit 172 determines that at least one of the motor generators MG1 and MG2 (or the vehicle 1) is not stopped (step S239).

On the other hand, when it is determined that the stop determination condition is satisfied as a result of determination of step S230 (Yes in step S230), the stop determination unit 172, as in the case of the first embodiment, determines whether the duration of the state where the stop determination condition is satisfied is longer than or equal to the predetermined time (step S101 to step S103).

When it is determined that the duration of the state where the stop determination condition is satisfied is not longer than or equal to the predetermined time as a result of determination of step S102 and step S103 (No in step S102), the stop determination unit 172 determines that the motor generators MG1, MG2 (or the vehicle 1) are not stopped (step S239).

On the other hand, when it is determined that the duration of the state where the stop determination condition is satisfied is longer than or equal to the predetermined time as a result of determination of step S102 and step S103 (Yes in step S102 and Yes in step S103), the stop determination unit 172 determines that the motor generators MG1, MG2 (or the vehicle 1) are stopped (step S234).

After that, when it is determined that the motor generators MG1, MG2 (or the vehicle 1) are stopped, the ECU 17 (or another component, such as the ground fault detector 19) may execute the operation that should be executed while the motor generators MG1, MG2 (or the vehicle 1) are stopped. In the third operation example, when it is determined that the motor generators MG1, MG2 (or the vehicle 1) are stopped, the inverter control unit 171 controls the operations of the inverters 13-1, 13-2 so as to execute three-phase short-circuit control (step S235). In the three-phase short-circuit control, the state of each of the motor generators MG1, MG2 is fixed in a three-phase short-circuit state. However, in the third operation example, as well as the first embodiment, the inverter control unit 171 may control the operations of the inverters 13-1, 13-2 so as to execute control in which the state of each of the motor generators MG1, MG2 is set to a state other than the three-phase short-circuit state. In addition, when it is determined that the motor generators MG1, MG2 (or the vehicle 1) are stopped, the ground fault detector 19 carries out detection of a ground fault in the electrical system while the three-phase short-circuit control is being executed (step S235).

In parallel with the operation of step S235, the stop determination unit 172 determines whether a predetermined stop cancellation condition is satisfied (step S236). The stop cancellation condition according to the third operation example includes the stop cancellation condition according to the first embodiment (that is, the stop cancellation condition based on the rotation speed Ne2 of the motor generator MG2 and the stop cancellation condition based on whether there is the stop operation). In addition, the stop cancellation condition according to the third operation example includes the stop determination condition based on the rotation speed Ne1 of the motor generator MG1 (that is, part of the stop cancellation condition according to the first operation example). However, the stop cancellation condition according to the third operation example may include the stop determination condition based on the operation situation of the engine ENG (that is, part of the stop cancellation condition according to the second operation example) in addition to or instead of the stop determination condition based on the rotation speed Ne1 of the motor generator MG1 (that is, part of the stop cancellation condition according to the first operation example).

When it is determined that the stop cancellation condition is not satisfied as a result of determination of step S236 (No in step S236), the inverter control unit 171 continues to control the operations of the inverters 13-1, 13-2 so as to continue executing three-phase short-circuit control. Similarly, the ground fault detector 19 continues to carry out detection of a ground fault of the electrical system.

On the other hand, when it is determined that the stop cancellation condition is satisfied as a result of determination of step S236 (Yes in step S236), the stop determination unit 172 determines that the motor generators MG1, MG2 (or the vehicle 1) are not stopped (step S237). In this case, the inverter control unit 171 may control the operations of the inverters 13-1, 13-2 so as not to execute three-phase short-circuit control in which the state of each of the motor generators MG1, MG2 is fixed to the three-phase short-circuit state (step S238). Similarly, the ground fault detector 19 ends detection of a ground fault in the electrical system (step S238).

As described above, in the third operation example as well, similar advantageous effects to the various advantageous effects obtained in the first operation example are suitably obtained.

The invention is not limited to the above-described embodiments; it may be modified as needed within the scope of the invention read from the appended claims and the specification or without departing from the spirit of the invention. A vehicle control device having such modifications is also included in the technical scope of the invention.

What is claimed is:

1. A vehicle control device that controls a vehicle including a first electric motor that is driven at a rotation speed synchronized with a rotation speed of a drive shaft of the vehicle, the vehicle control device comprising:
an electronic control unit configured to:
(a) carry out first determination as to whether the rotation speed of the first electric motor is lower than or equal to a first threshold and whether a stop operation that stops the vehicle is being carried out, and
(b) carry out second determination that the vehicle is stopped when in the first determination the electronic control unit determines that the rotation speed of the first electric motor is lower than or equal to the first threshold and the stop operation is being carried out.

2. The vehicle control device according to claim 1, wherein
the first electric motor is a three-phase alternating-current motor,
the vehicle includes a pair of serially connected first switching element and second switching element in each of the three phases of the first electric motor,
the vehicle further includes a first power converter that converts direct-current power to alternating-current power, the direct-current power being supplied to the first electric motor, and
the electronic control unit is configured to execute first control that controls the first power converter such that a state of the first power converter is set to a specific state where one of the set of first switching elements all and the set of second switching elements all are in an off state and at least one switching element of the other one of the set of first switching elements and the set of second switching elements is in an on state, when the electronic control unit has carried out the second determination that the vehicle is stopped.

3. The vehicle control device according to claim 2, wherein
the vehicle further includes a ground fault detector that detects a ground fault in an electrical system including the first electric motor, and
the electronic control unit is configured to control the first power converter such that the state of the first power converter becomes the specific state when the electronic control unit has carried out the second determination that the vehicle is stopped, and
the electronic control unit is configured to control the ground fault detector such that the ground fault detector carries out detection of the ground fault when the state of the first power converter is the specific state.

4. The vehicle control device according to claim 3, wherein
the electronic control unit is configured to control the ground fault detector such that the ground fault detector carries out detection of the ground fault, and
the electronic control unit is configured to determine that the first electric motor is not stopped when a stop cancellation condition is satisfied in the vehicle after the detection is carried out.

5. The vehicle control device according to claim 4, wherein
the stop cancellation condition includes a condition that the rotation speed of the first electric motor is higher than a second threshold or a condition that the stop operation is not being carried out.

6. The vehicle control device according to claim 4, wherein
the electronic control unit is configured to determine that the first electric motor is not stopped when the stop cancellation condition is satisfied, and
the electronic control unit is configured to cancel the specific state and end the detection of the ground fault after determining that the first electric motor is not stopped.

7. The vehicle control device according to claim 1, wherein
the electronic control unit is configured to carry out the second determination that the vehicle is stopped, when a duration of a state is longer than or equal to a predetermined period, the state being where in the first determination the electronic control unit determines that the rotation speed of the first electric motor is lower than or equal to the first threshold and the stop operation is being carried out.

8. The vehicle control device according to claim 1, wherein
the vehicle further includes a second electric motor coupled to the first electric motor via a power split mechanism, and
the electronic control unit is configured to further determine in the first determination whether a rotation speed of the second electric motor is lower than or equal to a third threshold, and
the electronic control unit is configured to carry out the second determination that the vehicle is stopped when the electronic control unit determines in the first determination that the rotation speed of the first electric motor is lower than or equal to the first threshold, the stop operation is being carried out and the rotation speed of the second electric motor is lower than or equal to the third threshold.

9. The vehicle control device according to claim 8, wherein
the second electric motor is a three-phase alternating-current motor,
the vehicle includes a pair of serially connected third switching element and fourth switching element in each of the three phases of the second electric motor,
the vehicle further includes a second power converter that converts direct-current power to alternating-current power, the direct-current power being supplied to the second electric motor, and
the electronic control unit is configured to execute second control that controls the second power converter such that a state of the second power converter is set to a specific state where one of the set of third switching elements all and the set of fourth switching elements all are in an off state and at least one switching element of the other one of the set of third switching elements and the set of fourth switching elements is in an on state, when the electronic control unit has carried out the second determination that the vehicle is stopped.

10. The vehicle control device according to claim 9, wherein
the vehicle further includes a ground fault detector that detects a ground fault in an electrical system including the second electric motor, and
the electronic control unit is configured to execute the second control that controls the second power converter such that the state of the second power converter becomes the specific state when the electronic control unit has determined that the second electric motor is stopped, and
the electronic control unit is configured to control the ground fault detector such that the ground fault detector carries out detection of the ground fault when the state of the second power converter is the specific state.

11. The vehicle control device according to claim 10, wherein
the electronic control unit is configured to control the ground fault detector such that the ground fault detector carries out detection of the ground fault, and
the electronic control unit is configured to determine that the second electric motor is not stopped when a stop cancellation condition is satisfied in the vehicle after the detection is carried out.

12. The vehicle control device according to claim 11, wherein
the stop cancellation condition includes a condition that the first electric motor is not stopped or a condition that the rotation speed of the second electric motor is higher than a fourth threshold.

13. The vehicle control device according to claim 11, wherein
the stop cancellation condition includes a condition that the first electric motor is not stopped or a condition that an engine is not stopped.

14. The vehicle control device according to claim 11, wherein
the stop cancellation condition includes a condition that the rotation speed of the first electric motor is higher than a second threshold, a condition that the rotation speed of the second electric motor is higher than a fourth threshold, or a condition that the stop operation that stops the vehicle is not being carried out.

15. The vehicle control device according to claim 11, wherein
the electronic control unit is configured to cancel the specific state and end the detection of the ground fault of the second electric motor when the stop cancellation condition is satisfied in the vehicle.
